(19) United States
(12) Patent Application Publication
(10) Pub. No.: US 2025/0034317 A1
(43) Pub. Date: Jan. 30, 2025

(54) POLYURETHANE ELASTOMER WITH IMPROVED HYDROLYSIS RESISTANCE

(71) Applicant: Covestro Deutschland AG, Leverkusen (DE)

(72) Inventors: Clementine Dimeck, Saint Lattier (FR); Assia Hamdaoui, Bourg-Lès-Valence (FR); Anne-Marie Monnet, Peyrins (FR); Helene Vigouroux, Chonas l'Amballan (FR); Aurelie Perrenot, Mours St Eusebe (FR)

(21) Appl. No.: 18/716,995

(22) PCT Filed: Dec. 5, 2022
(86) PCT No.: PCT/EP2022/084392

§ 371 Date: Jun. 6, 2024

(30) Foreign Application Priority Data
Dec. 8, 2021 (EP) 21213037.1

(51) Int. Cl. C08G 18/66; C08G 18/12; C08G 18/32; C08G 18/40; C08G 18/42; C08G 18/64; C08L 75/12

(52) U.S. Cl. CPC C08G 18/664; C08G 18/12; C08G 18/3206; C08G 18/4081; C08G 18/4238; C08G 18/6415; C08L 75/12; C08L 2205/025

(57) ABSTRACT

The present invention relates to polyurethane elastomers, obtainable or obtained from the reaction of at least one NCO-terminated prepolymer (A), at least one polyol mixture (B), obtainable or obtained by mixing at least one polyester (B1) having a number average molecular weight (Mn) in the range of 900 g/mol to 3000 g/mol and a hydroxyl functionality of ≥1.7 and ≤4, wherein Mn has been determined by gel permeation chromatography and (B2) at least one carbodiimide (B2), at least one chain extender (C), wherein the polyol mixture (B) was stored for at least 4 weeks at 23° C. after mixing of (B1) and (B2), a process for the manufacturing of those polyurethane elastomers, a kit-of-parts and to the use of those polyurethane elastomers.

The present invention relates to polyurethane elastomers, obtainable or obtained from the reaction of at least one NCO-terminated prepolymer (A), at least one polyol mixture (B), obtainable or obtained by mixing at least one polyester (B1) having a number average molecular weight (Mn) in the range of 900 g/mol to 3000 g/mol and a hydroxyl functionality of ≥1.7 and ≤4, wherein Mn has been determined by gel permeation chromatography and (B2) at least one carbodiimide (B2), at least one chain extender (C), wherein the polyol mixture (B) was stored for at least 4 weeks at 23° C. after mixing of (B1) and (B2), a process for the manufacturing of those polyurethane elastomers, a kit-of-parts and to the use of those polyurethane elastomers.

Polyurethane elastomers are used widely used in various applications, for example as rubber substitute in several applications in mining, since they are inexpensive to produce and do not have the disadvantages of rubber such as high abrasion and low rebound resilience. However, the use of polyurethane elastomers in applications with harsh conditions for the material require still an increase of the mechanical and chemical properties of the polyurethane elastomers. Especially in mining applications, where the polyurethane elastomers are exposed to mechanical stress in a corrosive and moist environment is an urgent demand for polyurethane elastomers with improved properties.

Objective of the present invention is therefore to provide a polyurethane elastomer having improved physical and mechanical properties, in particular in respect of hydrolysis resistance. In addition, it has been an objective to provide a process for manufacturing of polyurethane elastomers with an improved hydrolysis resistance.

The objectives are solved by the polyurethane elastomers of the present invention, obtainable or obtained from the reaction of
(A) at least one NCO-terminated prepolymer,
(B) at least one polyol mixture, obtainable or obtained by mixing
   (B1) at least one polyester polyol having a number average molecular weight (Mn) in the range of 900 g/mol to 3000 g/mol and a hydroxyl functionality of ≥1.7 and ≤4, wherein Mn has been determined by gel permeation chromatography and
   (B2) at least one carbodiimide,
(C) at least one chain extender,
(D) optionally at least one catalyst,
(E) optionally at least one additive, and/or
(F) optionally at least one filler characterized in that the polyol mixture (B) was stored for at least 4 weeks at 23° C. after mixing of (B1) and (B2).

These objectives have been further solved by a process for the preparation an elastomeric polyurethane according to the present invention.

These objectives have been further solved by a kit-of-parts comprising
(A) at least one NCO-terminated prepolymer,
(B) at least one polyol mixture, obtainable or obtained by mixing
   (B1) at least one polyester polyol having a number average molecular weight (Mn) in the range of 900 g/mol to 3000 g/mol and a hydroxyl functionality of ≥1.7 and ≤4, wherein Mn has been determined by gel permeation chromatography and
   (B2) at least one carbodiimide and
(C) at least one chain extender,
(D) optionally at least one catalyst,
(E) optionally at least one additive, and/or
(F) optionally at least one filler, characterized in that the polyol mixture (B) was stored for at least 4 weeks at 23° C. after mixing of (B1) and (B2).

These objectives have been further solved by the use of these elastomeric polyurethane for the manufacture of equipment for the mining, quarry or cement industry and the use of these elastomeric polyurethanes in offshore and marine applications, pulp and paper applications, shoe soles, railway applications, military applications, transport applications, industrial rolls, industrials tires, electric encapsulation, wheels, rollers, doctor blades, hydro cyclones, sieves, sport tracks, insulating panels, acoustic insulations, wind blades or bumpers.

In accordance with the present invention it has been surprisingly found by the applicant that the claimed polyurethane elastomer or a composition comprising or containing the claimed polyurethane elastomer exhibits an improved hydrolysis resistance, even at a temperature of 70° C., an enhanced abrasion resistance, as well as during hydrolysis exposure and maintaining a high resilience at the same time.

According to the present invention the wording “elastomeric” or “elastomer” means a polyurethane having/alternance of polyols macromolecular chains corresponding to “soft segment”, with urethane reticulation bonding to short segments called “hard segment” composed of urethane bonding.

The single components of the polyurethane elastomer and/or the kit-of-parts according to the present invention will be described in detail in the following.

Component (A) of the polyurethane elastomer and/or the kit-of-parts according to the present invention is at least one NCO-terminated prepolymer (A) obtainable or obtained from the reaction of
(A1) at least one polyisocyanate comprising at least two isocyanate groups, and
(A2) at least one polyol having a number average molecular weight (Mn) in the range of 900 g/mol to 3000 g/mol and a hydroxyl functionality of ≥1.7 and ≤4, wherein Mn has been determined by gel permeation chromatography,
(A3) optionally at least one polyol having a molecular weight in the range of 90 g/mol and 150 g/mol and/or
(A4) optionally at least one catalyst and/or at least one additive.

Component (A1), the at least one polyisocyanate (A1) comprising at least two isocyanate groups, can preferably be selected from the group consisting of aromatic diisocyanates, more preferably selected from the group consisting of toluene-2,4-diisocyanate (2,4-TDI), toluene-2,4-diisocyanate (2,4-TDI)/toluene-2,6-diisocyanate (2,6-TDI) mixtures, diphenylmethane-4,4′-diisocyanate (4,4′-MDI), diphenylmethane-2,4′-diisocyanate (2,4′-MDI), diphenylmethane-2,2′-diisocyanate (2,2′-MDI), diphenylmethane-2,4′-diisocyanate (2,4′-MDI)/diphenylmethane-4,4′-diisocyanate (4,4′-MDI) mixtures, urethane-modified liquid diphenylmethane-4,4′-diisocyanates and diphenylmethane-2,4′-diisocyanates, 4,4′-diisocyanato-1,2-diphenylethane, naphthylene-1,5-diisocyanate and mixtures of at least 2 thereof, even more preferably selected from the group consisting of diphenylmethane-4,4′-diisocyanate (4,4′-MDI), diphenylmethane-2,4′-diisocyanate (2,4′-MDI), diphenylmethane-2,4′-diisocyanate (2,4′-MDI)/diphenylmethane-4,4′-diisocyanate (4,4′-MDI) mixtures, diphenylmethane-2,2′-diisocyanate (2,2′-MDI) and mixtures of at least 2 thereof.

The diisocyanates mentioned can be used individually or in the form of mixtures with one another. They can also be used together with up to 15% by weight (based on the total quantity of diisocyanate) of a higher functional polyisocyanate, for example triphenylmethane-4,4′,4″-triisocyanate or with polyphenyl polymethylene polyisocyanates.

Other polyisocyanates (A1) that can be used are aliphatic and cycloaliphatic diisocyanates. Mention may be made by way of example of hexamethylene diisocyanate (HDI), isophorone diisocyanate (IPDI), cyclohexane-1,4-diisocyanate, 1-methylcyclohexane-2,4-diisocyanate, and dicyclohexylmethane-4,4′-, -2,4′-, and -2,2′-diisocyanate, and also the corresponding isomer mixtures.

According to the present invention the wording “polyisocyanate” also means polyisocyanates having at least two isocyanate groups which have been modified, for example by 1-Methylphospholene-1-oxide (MPO), ethyl trifluoromethanesulphonate and/or carbodiimide. According to a preferred embodiment a carbodiimide modified polyisocyanate is used according to the present invention, in particular in combination with non-modified polyisocyanates.

Component (A1) is in general used in an amount of 5 to 90 wt. % based on the total weight of the at least one prepolymer (A).

Component (A2), the at least one polyol having a number average molecular weight (Mn) in the range of 900 g/mol to 3000 g/mol and a hydroxyl functionality of ≥1.7 and ≤4, wherein Mn has been determined by gel permeation chromatography, is selected preferably from the group consisting of polyester polyol, polyether polyol, polyether carbonate polyol and mixtures of at least 2 thereof, more preferably a polyester polyol, even more preferably a polyester polyol having a number average molecular weight (Mn) in the range of 1000 g/mol to 2500 g/mol and a hydroxyl functionality of ≥1.7 and ≤4, wherein Mn has been determined by gel permeation chromatography.

The number-average molecular weight (Mn) was determined by gel permeation chromatography (GPC) in tetrahydrofuran at 23° C. The procedure is according to DIN 55672-1: “Gel permeation chromatography, Part 1—Tetrahydrofuran as eluent” (SECurity GPC System from PSS Polymer Service, flow rate 1.0 ml/min; columns: 2×PSS SDV linear M, 8×300 mm, 5 μm; RID detector).

Polystyrene samples of known molar mass are used for calibration. The number-average molecular weight is calculated with software support. Baseline points and evaluation limits are fixed in accordance with DIN 55672 Part 1.

The at least one polyol (A2) is preferably a diol having a number average molecular weight (Mn) in the range of 900 g/mol to 3000 g/mol and a hydroxyl functionality of ≥1.7 and ≤4, wherein Mn has been determined by gel permeation chromatography, more preferably a polyester diol having a number average molecular weight (Mn) in the range of 1000 g/mol to 2500 g/mol and a hydroxyl functionality of ≥1.7 and ≤4, wherein Mn has been determined by gel permeation chromatography.

Suitable polyether polyols can thus be produced by reacting one or more alkylene oxides having from 2 to 4 carbon atoms in the alkylene moiety with a starter molecule which comprises two active hydrogen atoms. Examples that may be mentioned of alkylene oxides are: ethylene oxide, 1,2-propylene oxide, epichlorohydrin, and 1,2-butylene oxide, and 2,3-butylene oxide. It is preferable to use ethylene oxide, propylene oxide, and mixtures of 1,2-propylene oxide and ethylene oxide. The alkylene oxides can be used individually, in alternating succession, or in the form of mixtures. Examples of starter molecules that can be used are: water, amino alcohols, for example N-alkyldiethanolamines, for example N-methyldiethanolamine, and diols, for example ethylene glycol, 1,3-propylene glycol, 1,4-butanediol, and 1,6-hexanediol. Mixtures of starter molecules can optionally also be used. Other suitable polyether diols are the tetrahydrofuran polymerization products containing hydroxyl groups. It is also possible to use proportions of from 0 to 30% by weight, based on the bifunctional polyethers, of trifunctional polyethers, the quantity of these being however at most that which produces a thermoplastically processible product. The average molar masses Mn of suitable polyether polyols is from 900 to 3000 g/mol, preferably from 1000 to 2500 g/mol. The suitable polyether polyols have a hydroxyl functionality of ≥1.7 and ≤4. They can be used either individually or else in the form of mixtures with one another.

Suitable polyester polyols can by way of example be produced from dicarboxylic acids having from 2 to 12 carbon atoms, preferably having from 4 to 6 carbon atoms, and from polyhydric alcohols. Examples of dicarboxylic acids that can be used are: aliphatic dicarboxylic acids, for example succinic acid, maleic acid, glutaric acid, adipic acid, suberic acid, azelaic acid, and sebacic acid, and aromatic dicarboxylic acids, for example phthalic acid, isophthalic acid, and terephthalic acid. The dicarboxylic acids can be used individually or in the form of mixtures, e.g. in the form of a succinic, glutaric, and adipic acid mixture. For the production of the polyester diols it can optionally be advantageous to use, instead of the dicarboxylic acids, the corresponding dicarboxylic acid derivatives, for example carboxylic diesters having from 1 to 4 carbon atoms in the alcohol moiety, carboxylic anhydrides, or acyl chlorides. Examples of polyhydric alcohols are glycols having from 2 to 10, preferably from 2 to 6, carbon atoms, for example ethylene glycol, diethylene glycol, 1,4-butanediol, 1,5-pentanediol, 1,6-hexanediol, 1,10-decanediol, 1,12-dodecanediol, 2,2-dimethyl-1,3 propanediol, 1,3-propanediol, and dipropylene glycol. The polyhydric alcohols can be used alone or optionally in a mixture with one another, as required by the desired properties. Other suitable compounds are esters of carbonic acid with the diols mentioned, in particular those having from 4 to 6 carbon atoms, for example 1,4-butanediol or 1,6-hexanediol, condensates of hydroxycarboxylic acids, for example hydroxycaproic acid, and polymerization products of lactones, for example optionally substituted caprolactones. Preferred polyester diols used are ethanediol polyadipates, 1,4-butanediolpolyadipates, ethanediol-1,4-butanediol-polyadipates, 1,6-hexanediol neopentyl glycol polyadipates, 1,6-hexanediol-1,4-butanediol polyadipates, and polycaprolactones. The number-average molar mass Mn of the polyester polyols is from 900 to 3000 g/mol, preferably from 1000 to 2500 g/mol. The suitable polyester polyols have a hydroxyl functionality of ≥1.7 and ≤4. They can be used either individually or else in the form of mixtures with one another.

Suitable polyether carbonate polyols are obtainable by copolymerization of carbon dioxide and alkylene oxides in the presence of H-functional starter compounds or by addition of cyclic carbonate, preferably cyclic propylene carbonate and/or cyclic ethylene carbonate, to H-functional starter compounds, where the polyether carbonate polyol preferably has a CO₂ content of from 5 to 25% by weight. For the purposes of the invention, the expression “H-functional” refers to a starter compound which has H atoms which are active in respect of alkoxylation.

The polyether carbonate polyols used in accordance with the invention preferably also have ether groups between the carbonate groups, shown schematically in formula (I). In the scheme according to formula (I), R is an organic radical such as alkyl, alkylaryl or aryl which can in each case also contain heteroatoms such as O, S, Si, etc.; e and f are each an integer. The polyether carbonate polyol shown in the scheme according to formula (I) should be considered to mean merely that blocks having the structure shown can in principle recur in the polyether carbonate polyol but the order, number and length of the blocks can vary and is not restricted to the polyether carbonate polyol shown in formula (I). In relation to formula (I), this means that the ratio of e/f is preferably from 2:1 to 1:20, particularly preferably from 1.5:1 to 1:10.

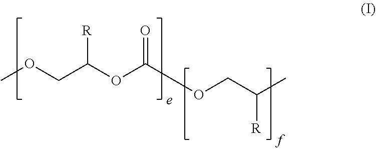

The proportion of incorporated CO2 (“units derived from carbon dioxide”; “CO2 content”) in a polyether carbonate polyol can be determined from the evaluation of characteristic signals in the 1H NMR spectrum. The following example illustrates the determination of the proportion of units derived from carbon dioxide in a 1,8-octanediol-initiated CO2/propylene oxide polyether carbonate polyol.

The proportion of incorporated CO2 in a polyether carbonate polyol and the ratio of propylene carbonate to polyether carbonate polyol can be determined by means of ¹H NMR as outlined in the prior art.

In general, alkylene oxides (epoxides) having 2 to 24 carbon atoms can be used for preparing the polyether carbonate polyols A1. The alkylene oxides having from 2 to 24 carbon atoms are for example one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, monoepoxidized or polyepoxidized fats as monoglycerides, diglycerides and triglycerides, epoxidized fatty acids, C1-C24 esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3-glycidyloxypropyltrimethoxysilane, 3-glycidyloxypropyltriethoxysilane, 3-glycidyloxypropyltripropoxysilane, 3-glycidyloxypropyl-methyldimethoxysilane, 3-glycidyloxypropylethyldiethoxysilane, 3-glycidyloxypropyltriiso-propoxysilane. Preference is given to using ethylene oxide and/or propylene oxide and/or 1,2-butylene oxide, particularly preferably propylene oxide, as alkylene oxides.

In a preferred embodiment of the invention, the proportion of ethylene oxide in the total amount of propylene oxide and ethylene oxide used is from ≥0 to ≤90% by weight, preferably from ≥0 to ≤50% by weight, and is particularly preferably free of ethylene oxide.

As suitable H-functional starter compounds, it is possible to use compounds having H atoms which are active in respect of alkoxylation. Groups active in respect of the alkoxylation and having active hydrogen atoms are, for example, —OH, —NH2 (primary amines), —NH— (secondary amines), SH, and —CO2H, preferably —OH and —NH2, more preferably —OH. As H-functional starter compounds, use is made of, for example, one or more compounds selected from the group consisting of water, mono- or polyhydric alcohols, polyfunctional amines, polyhydric thiols, amino alcohols, thio alcohols, hydroxy esters, polyether polyols, polyester polyols, polyester ether polyols, polyether carbonate polyols, polycarbonate polyols, polycarbonates, polyethyleneimines, polyetheramines (e.g. Jeffamines® from Huntsman, e.g. D-230, D-400, D 2000, T-403, T-3000, T-5000, or corresponding products from BASF, e.g. polyetheramine D230, D400, D200, T403, T5000), polytetrahydrofurans (e.g. PolyTHF® from BASF, e.g. PolyTHF® 250, 6505, 1000, 10005, 1400, 1800, 2000), polytetrahydrofuranamines (BASF product polytetrahydrofuranamine 1700), polyether thiols, polyacrylate polyols, castor oil, the monoglyceride or diglyceride of ricinoleic acid, monoglycerides of fatty acids, chemically modified monoglycerides, diglycerides and/or triglycerides of fatty acids, and C1-C24-alkyl fatty acid esters containing an average of at least 2 OH groups per molecule. By way of example, the C1-C24-alkyl fatty acid esters containing an average of at least 2 OH groups per molecule are commercial products such as Lupranol Balance® (from BASF AG), Merginol® products (from Hobum Oleochemicals GmbH), Sovermol® products (from Cognis Deutschland GmbH & Co. KG) and Soyol®™ products (from USSC Co.).

Monofunctional starter compounds used may be alcohols, amines, thiols and carboxylic acids. Monofunctional alcohols used may be: methanol, ethanol, 1-propanol, 2-propanol, 1-butanol, 2-butanol, t-butanol, 3-buten-1-ol, 3-butyn-1-ol, 2-methyl-3-buten-2-ol, 2-methyl-3-butyn-2-ol, propargyl alcohol, 2-methyl-2-propanol, 1-t-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Useful monofunctional amines include: butylamine, t-butylamine, pentylamine, hexylamine, aniline, aziridine, pyrrolidine, piperidine, morpholine. Monofunctional thiols used may be: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Polyhydric alcohols with suitability as H-functional starter compounds are, for example, dihydric alcohols (such as, for example, ethylene glycol, diethylene glycol, propylene glycol, dipropylene glycol, 1,3-propanediol, 1,4-butanediol, 1,4-butenediol, 1,4-butynediol, neopentyl glycol, 1,5-pentantanediol, methylpentanediols (such as, for example, 3-methyl-1,5-pentanediol), 1,6-hexanediol; 1,8-octanediol, 1,10-decanediol, 1,12-dodecanediol, bis(hydroxymethyl)cyclohexanes (such as, for example, 1,4-bis(hydroxymethyl)cyclohexane), triethylene glycol, tetraethylene glycol, polyethylene glycols, dipropylene glycol, tripropylene glycol, polypropylene glycols, dibutylene glycol, and polybutylene glycols); trihydric alcohols (such as, for example, trimethylolpropane, glycerol, trishydroxyethyl isocyanurate, castor oil); tetrahydric alcohols (such as, for example, pentaerythritol); polyalcohols (such as, for example, sorbitol, hexitol, sucrose, starch, starch hydrolyzates, cellulose, cellulose hydrolyzates, hydroxy-functionalized fats and oils, especially castor oil), and also all products of modification of these aforementioned alcohols with different amounts of ε-caprolactone. In mixtures of H-functional starters, it is also possible to use trihydric alcohols, for example trimethylolpropane, glycerol, trishydroxyethyl isocyanurate and castor oil.

The H-functional starter compounds can also be selected from the class of polyether polyols, polyester polyols and/or polycarbonate polyols.

It is likewise possible to use polyether carbonate polyols as H-functional starter compounds. In particular, polyether carbonate polyols prepared by the above-described process are used. For this purpose, these polyether carbonate polyols used as H-functional starter compounds are prepared in a separate reaction step beforehand.

Preferred H-functional starter compounds are alcohols as mentioned above.

In a preferred embodiment of the invention, the polyether carbonate polyol B is obtainable by addition of carbon dioxide and alkylene oxides onto H-functional starter compounds using multimetal cyanide catalysts (DMC catalysts). The preparation of polyether carbonate polyols by addition of alkylene oxides and CO₂ onto H-functional starter compounds using DMC catalysts is known, for example, from EP-A 0222453, WO-A 2008/013731 and EP-A 2115032.

DMC catalysts are known in principle from the prior art for homopolymerization of epoxides (see, for example, U.S. Pat. Nos. 3,404,109, 3,829,505, 3,941,849 and 5,158,922). DMC catalysts which are described, for example, in U.S. Pat. No. 5,470,813, EP-A 700 949, EP-A 743 093, EP-A 761 708, WO-A 97/40086, WO-A 98/16310 and WO-A 00/47649 have a very high activity in the homopolymerization of epoxides and make it possible to prepare polyether polyols and/or polyether carbonate polyols at very low catalyst concentrations (25 ppm or less). A typical example is the highly active DMC catalysts described in EP-A 700 949 which in addition to a double metal cyanide compound (e.g., zinc hexacyanocobaltate (III)) and an organic complexing ligand (e.g., t-butanol) contain a polyether having a number-average molecular weight Mn of greater than 500 g/mol.

The number-average molar mass Mn of the polyether carbonate polyols is from 900 to 3000 g/mol, preferably from 1000 to 2500 g/mol. The suitable polyether carbonate polyols have a hydroxyl functionality of ≥1.7 and ≤4. They can be used either individually or else in the form of mixtures with one another.

Component (A2) is in general used in an amount of 5 to 90 wt. % based on the total weight of the at least one prepolymer (A).

Component (A3), the a least one polyol having a molecular weight in the range of 90 g/mol and 150 g/mol (A3), is preferably a polyol having a hydroxyl functionality of ≥2 and ≤4, more preferably the content of (A3) in the NCO-terminated prepolymer (A) is in the range of 0.5 to 5 wt. % based on the total weight of the at least one NCO-terminated prepolymer (A).

Suitable polyols as compound (A3) are 1,2-ethanediol, 1,2-propanediol, 1,3-propanediol, 1,2-butanediol, 1,3-butanediol, 1,4-butanediol, 1,5-pentanediol, 2,2-dimethylpropane-1,3-diol, 2-butyl-2-ethyl propane-1,3-diol, 2-methyl-2,4-pentane diol, 2-ethyl-1,3-hexane diol, 2-methyl-1,3-propane diol, 1,5-hexanediol, 1,6-hexanediol, 1,8-octanediol, 2,2,4,4-tetramethylcyclobutane-1,3-diol, 1,3-cyclopentanediol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, diethylene glycol, triethylene glycol, dipropylene glycol, trimethylolpropane, trimethylolethane, triisopropanolamine and pentaerythritol.

In a preferred embodiment the at least one polyol (A3) is selected from the group consisting of 1,2-ethanediol, 1,2-propanediol, 1,3-propanediol, 1,2-butanediol, 1,3-butanediol, 1,4-butanediol, 1,5-pentanediol, 1,5-hexanediol, 1,6-hexanediol, 1,8-octanediol, diethylene glycol, trimethylolethane, pentaerythritol, triethylene glycol, trimethylolpropane and mixtures of at least 2 thereof.

The polyols (A3) mentioned can be used individually or in the form of mixtures with one another.

Component (A3) is in general used in an amount of 0.5 to 5 wt. % based on the total weight of the at least one prepolymer (A).

The at least one prepolymer (A) according to the present invention is obtainable in the presence of (A4) optionally at least one catalyst and/or at least one additive.

Suitable catalysts can optionally be used in the process of the invention. The conventional tertiary amines known from the prior art, e.g. triethylamine, dimethylcyclohexylamine, N-methylmorpholine, N,N′-dimethylpiperazine, 2-(dimethylaminoethoxy)ethanol, diazabicyclo[2.2.2]octane (DABCO), diethylethanolamine, N-cocomorpholine, N,N-diethyl-3-diethylaminopropylamine dimethylbenzylamine, 1,8-Diazabicycloundec-7-ene (DBU), triazabicyclodecene (TBD) and N-methyltriazabyclodecene (MTBD). Organometallic compounds, for example titanium compounds, iron compounds, bismuth compounds, zinc compounds, or tin compounds, for example tin diacetate, tin dioctanoate, tin dilaurate, or the dialkyltin salts of aliphatic carboxylic acids, for example dibutyltin diacetate or dibutyltin dilaurate, are suitable catalysts for the production of PU elastomers. Preferred catalysts are amine compounds and/or organometallic compounds, in particular tin compounds.

Suitable additives may be lubricants, for example fatty acid esters, metal soaps of these, fatty acid amides, fatty acid ester amides, and silicone compounds, anti-foaming agents, rheological agents such as viscosity regulator, jellification agents, antiblocking agents, inhibitors, stabilizers with respect to hydrolysis, UV or other light, heat, and discoloration.

In another preferred embodiment, additives used in small amounts may also be customary mono-, di-, tri- or polyfunctional compounds reactive toward isocyanates in proportions of 0.001 mol % up to 2 mol %, preferably of 0.002 mol % to 1 mol %, based on the total molar amount of component A, for example as chain terminators, auxiliaries or demoulding aids. Examples include alcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol and stearyl alcohol. Examples of suitable triols are trimethylolethane, trimethylolpropane or glycerol. Suitable higher-functionality alcohols are ditrimethylolpropane, pentaerythritol, dipentaerythritol or sorbitol. Amines such as butylamine and stearylamine or thiols.

The NCO-terminated prepolymer (A) is obtained from the components as mentioned before. The preparation of a prepolymer is in general known to the skilled artisan in the art.

In a preferred embodiment, the at least one NCO-terminated prepolymer (A) is obtained or obtainable from the reaction of
(A1) least one polyisocyanate (A1) selected from the group consisting of aromatic diisocyanates, preferably selected from the group consisting of toluene-2,4-diisocyanate (2,4-TDI), toluene-2,4-diisocyanate (2,4-TDI)/toluene-2,6-diisocyanate (2,6-TDI) mixtures, diphenylmethane-4,4′-diisocyanate (4,4′-MDI), diphenylmethane-2,4′-diisocyanate (2,4′-MDI), diphenylmethane-2,2′-diisocyanate (2,2′-MDI), diphenylmethane-2,4′-diisocyanate (2,4′-MDI)/diphenylmethane-4,4′-diisocyanate (4,4′-MDI) mixtures, urethane-modified liquid diphenylmethane-4,4′-diisocyanates and diphenylmethane-2,4′-diisocyanates, 4,4′-diisocyanato-1,2-diphenylethane, naphthylene-1,5-diisocyanate and mixtures of at least 2 thereof, more preferably selected from the group consisting of diphenylmethane-4,4′-diisocyanate (4,4′-MDI), diphenylmethane-2,4′-diisocyanate (2,4′-MDI), diphenylmethane-2,4′-diisocyanate (2,4′-MDI)/diphenylmethane-4,4′-diisocyanate (4,4′-MDI) mixtures, diphenylmethane-2,2′-diisocyanate (2,2′-MDI) and mixtures of at least 2 thereof,
(A2) at least one polyol having a number average molecular weight (Mn) in the range of 900 g/mol to 3000 g/mol and a hydroxyl functionality of ≥1.7 and ≤4, wherein Mn has been determined by gel permeation chromatography, selected from the group consisting of polyester polyol, polyether polyol, polyether carbonate polyol and mixtures of at least 2 thereof, preferably a polyester polyol, more preferably a polyester polyol having a number average molecular weight (Mn) in the range of 1000 g/mol to 2500 g/mol and a hydroxyl functionality of ≥1.7 and ≤4, wherein Mn has been determined by gel permeation chromatography,
(A3) optionally at least one polyol having a molecular weight in the range of 90 g/mol and 150 g/mol, preferably a polyol having a hydroxyl functionality of ≥2 and ≤4, more preferably wherein the content of (A3) is in the range of 0.5 to 5 wt. % based on the total weight of the at least one NCO-terminated prepolymer (A), and/or
(A4) optionally at least one catalyst and/or at least one additive.

The proportion of component (A), based on the total mass of the polyurethane elastomer is preferably 20 to 79.9% by weight, particularly preferably 25 to 65% by weight, with the provision that the sum of components (A), (B) and (C) in the polyurethane elastomer is 100% by weight.

Component (B) according to the present invention is at least one polyol mixture (B), obtainable or obtained by mixing at least one polyester polyol (B1) having a number average molecular weight (Mn) in the range of 900 g/mol to 3000 g/mol and a hydroxyl functionality of ≥1.7 and ≤4, wherein Mn has been determined by gel permeation chromatography and at least one carbodiimide (B2), wherein the polyol mixture (B) was stored for at least 4 weeks at 23° C. after mixing of (B1) and (B2).

Suitable polyester polyols can by way of example be produced from dicarboxylic acids having from 2 to 12 carbon atoms, preferably having from 4 to 6 carbon atoms, and from polyhydric alcohols. Examples of dicarboxylic acids that can be used are: aliphatic dicarboxylic acids, for example succinic acid, maleic acid, glutaric acid, adipic acid, suberic acid, azelaic acid, and sebacic acid, and aromatic dicarboxylic acids, for example phthalic acid, isophthalic acid, and terephthalic acid. The dicarboxylic acids can be used individually or in the form of mixtures, e.g. in the form of a succinic, glutaric, and adipic acid mixture. For the production of the polyester diols it can optionally be advantageous to use, instead of the dicarboxylic acids, the corresponding dicarboxylic acid derivatives, for example carboxylic diesters having from 1 to 4 carbon atoms in the alcohol moiety, carboxylic anhydrides, or acyl chlorides. Examples of polyhydric alcohols are glycols having from 2 to 10, preferably from 2 to 6, carbon atoms, for example ethylene glycol, diethylene glycol, 1,4-butanediol, 1,5-pentanediol, 1,6-hexanediol, 1,10-decanediol, 1,12-dodecanediol, 2,2-dimethyl-1,3 propanediol, 1,3-propanediol, and dipropylene glycol. The polyhydric alcohols can be used alone or optionally in a mixture with one another, as required by the desired properties. Other suitable compounds are esters of carbonic acid with the diols mentioned, in particular those having from 4 to 6 carbon atoms, for example 1,4-butanediol or 1,6-hexanediol, condensates of hydroxycarboxylic acids, for example hydroxycaproic acid, and polymerization products of lactones, for example optionally substituted caprolactones. Preferred polyester diols used are ethanediol polyadipates, 1,4-butanediolpolyadipates, ethanediol-1,4-butanediol-polyadipates, 1,6-hexanediol neopentyl glycol polyadipates, 1,6-hexanediol-1,4-butanediol polyadipates, and polycaprolactones. The number-average molar mass Mn of the polyester polyols is from 900 to 3000 g/mol, preferably from 1000 to 2500 g/mol. The suitable polyester polyols have a hydroxyl functionality of ≥1.7 and ≤4. They can be used either individually or else in the form of mixtures with one another.

Suitable carbodiimides are (1,3-bis(1-isocyanato-1-methylethyl)-benzene homopolymer, polyethylene glycol mono-Me ether blocked), bis(2,6-diisopropylphenyl)carbodiimide, N,N′-bis(2,4,6-Triisopropylphenyl)methandiimin, N,N′-dicyclohexylcarbodiimide, N-(3-dimdthylaminopropyl)-N′-ethylcarbodiimide, N-cyclohexyl-N′-isopropylcarbodiimide, N,N′-diisopropylcarbodiimide. The carbodiimide compound for the function includes 4,4′-dicyclohexylmethanecarbodiimide (degree of polymerization 2 to 20), tetramethylxylylenecarbodiimide (degree of polymerization 2 to 20), N,N-dimethylphenylcarbodiimide (degree of polymerization=2 to 20) and N,N′-di-2,6-diisopropylphenylcarbodiimide (degree of polymerization=2 to 20) and the like, and is not specifically limited as long as the compound has at least one carbodiimide group in a molecule having the function.

In one embodiment the carbodiimide is selected from the list consisting of 1,3-bis(1-isocyanato-1-methylethyl)-benzene homopolymer, polyethylene glycol mono-Me ether blocked), bis(2,6-diisopropylphenyl)carbodiimide, N,N′-bis(2,4,6-Triisopropylphenyl)methandiimin, tetramethylxylylenecarbodiimide (degree of polymerization 2 to 20), N,N-dimethylphenylcarbodiimide (degree of polymerization=2 to 20) and N,N′-di-2,6-diisopropylphenylcarbodiimide (degree of polymerization=2 to 20) and/or mixtures of at least 2 thereof.

The at least one carbodiimide (B2), is preferably at least one polycarbodiimide, more preferably an aromatic polycarbodiimide. In one embodiment the content of (B2) in the polyol mixture (B) is in the range of 1 to 5 wt. % based on the total weight of the at least one polyol mixture (B).

In a preferred embodiment, the at least one polyol mixture (B), is obtainable or obtained by mixing at least one polyester polyol (B1) having a number average molecular weight (Mn) in the range of 1000 g/mol to 2500 g/mol and a hydroxyl functionality of ≥1.7 and ≤4, wherein Mn has been determined by gel permeation chromatography, preferably a adipate ester based polyester and at least one carbodiimide (B2), preferably at least one polycarbodiimide, more preferably wherein the content of (B2) is in the range of 1 to 5 wt. % based on the total weight of the at least one polyol mixture (B).

In a preferred embodiment, polyol mixture (B) was stored for 4 weeks to 30 weeks, preferably for at least 6 weeks, more preferably for 6 weeks to 30 weeks, even more preferably for 8 weeks to 25 weeks and still more preferably for 10 weeks to 24 weeks at 23° C. after mixing of (B1) and (B2). However, it is also possible to reduce the storage time below 4 weeks by increasing the temperature to >23° C. The storage time is the time period one has to wait until polyol mixture (B) is formed and may also include transportation time, i.e. for example after mixing (B1) and (B2), the mixture is stored for two weeks at 23° C. and afterwards transported for additional 2 weeks to another location before the actual use.

The at least one polyol mixture (B) can be in general done in a suitable reactor by mixing the at least one polyester polyol (B1) with the at least one carbodiimide (B2) under suitable conditions known to the skilled artisan, for example under vacuum, and at a temperature of 70 to 100° C. during one hour to two hours. Preferably, no solvent is added. The mixture can be stored afterwards in a suitable drum under dry nitrogen or vacuum.

The proportion of component (B), based on the total mass of the polyurethane elastomer is preferably 20 to 79.9% by weight, particularly preferably 25 to 74.9% by weight, with the provision that the sum of components (A), (B) and (C) in the polyurethane elastomer is 100% by weight.

Component (C) according to the present invention is at least one chain extender (C). In one embodiment the chain extender (C) can comprise low-molecular-weight compounds with a molar mass of 60 to 490 g/mol, preferably 62 to 400 g/mol, and particularly preferably 62 to 300 g/mol, where these have at least two, in particular two, isocyanate-reactive groups.

In one preferred embodiment of the invention, the chain extender (C) comprise, or consist of, diols, diamines, or diol/diamine mixtures, however preferably diols.

Suitable chain extenders are diols such as ethanediol, 1,2-ethanediol, 1,2-propanediol, 1,3-propanediol, 1,2-butanediol, 1,3-butanediol, 1,4-butanediol, 1,5-pentanediol, 2,2-dimethylpropane-1,3-diol, 2-butyl-2-ethyl propane-1,3-diol, 2-methyl-2,4-pentane diol, 2-ethyl-1,3-hexane diol, 2-methyl-1,3-propane diol, 1,5-hexanediol, 1,6-hexanediol, 1,8-octanediol, 1,10-decanediol, 1,12-dodecanediol, 2,2,4,4-tetramethylcyclobutane-1,3-diol, 1,3-cyclopentanediol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, 1,4-cyclohexanediethanol, isosorbide, triisopropanolamine, glycerol monoesters, glycerol monoethers, trimethylolpropane monoesters, trimethylolpropane monoethers, pentaerythritol diesters, pentaerythritol diethers, and alkoxylated derivatives of any of these, diethylene glycol, triethylene glycol, tetraethylene glycol, higher poly(ethylene glycol), for example having number average molecular weights of from 220 to 2000 g/mol, dipropylene glycol, tripropylene glycol, and higher poly(propyleneglycols), alkoxylated derivative of a compound selected from the group consisting of a diacid, a diol, and a hydroxy acid, polymeric diol, preferably wherein the polymeric diol is selected from the group consisting of polyethers, polyesters, hydroxy-terminated polyolefins, polyether-copolyesters, polyether polycarbonates, polycarbonate-copolyesters, polyoxymethylene polymers, and alkoxylated analogs thereof, diesters of terephthalic acid with glycols having from 2 to 4 carbon atoms, for example bis(ethylene glycol)terephthlate or bis(1,4-butanediol)terephthlate, hydroxyalkylene ethers of hydroquinone, for example 1,4-di(hydroxyethyl)hydroquinone, and ethoxylated bisphenols, and also reaction products of these with c caprolactone.

Other suitable chain extenders are (cyclo)aliphatic diamines, for example isophoronediamine, ethylenediamine, 1,2-propylenediamine, 1,3-propylenediamine, N-methylpropylene-1,3-diamine, N,N′-dimethylethylenediamine, and aromatic diamines, for example 2,4-toluenediamine and 2,6-toluenediamine, 6-methyl-2,4-bis(methylthio)phenylene-1,3-diamine and 2-methyl-4,6-bis(methylthio)phenylene-1,3-diamine, 3,5-diethyl-2,4-toluenediamine, and 3,5-diethyl-2,6-toluenediamine, and primary mono-, di-, tri-, or tetraalkyl-substituted 4,4′-diamino-diphenylnethanes.

The at least one chain extender (C) is preferably selected from the group consisting of 1,2-ethanediol, 1,2-propanediol, 1,3-propanediol, 1,2-butanediol, 1,3-butanediol, 1,4-butanediol, 1,5-pentanediol, 2,2-dimethylpropane-25 1,3-diol, 2-butyl-2-ethyl propane-1,3-diol, 2-methyl-2,4-pentane diol, 2-ethyl-1,3-hexane diol, 2-methyl-1,3-propane diol, 1,5-hexanediol, 1,6-hexanediol, 1,8-octanediol, 1,10-decanediol, 1,12-dodecanediol, 2,2,4,4-tetramethylcyclobutane-1,3-diol, 1,3-cyclopentanediol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, 1,4-cyclohexanediethanol, isosorbide, glycerol, glycerol monoesters, glycerol monoethers, trimethylolpropane, trimethylolpropane monoesters, trimethylolpropane monoethers, pentaerythritol diesters, pentaerythritol diethers, and alkoxylated derivatives of any of these, diethylene glycol, triethylene glycol, tetraethylene glycol, dipropylene glycol, tripropylene glycol, bis(ethylene glycol)terephthalate, bis(1,4-butanediol)terephthlate, 1,4-di(hydroxyethyl)hydroquinone, isophoronediamine, ethylenediamine, 1,2-propylenediamine, 1,3-propylenediamine, N-methylpropylene-1,3-diamine, N,N′-dimethylethylenediamine, 2,4-toluenediamine and 2,6-toluenediamine, 6-methyl-2,4-bis(methylthio)phenylene-1,3-diamine and 2-methyl-4,6-bis(methylthio)phenylene-1,3-diamine, 3,5-diethyl-2,4-toluenediamine, 3,5-diethyl-2,6-toluenediamine and mixtures of at least 2 thereof, more preferably selected from the group consisting of 1,2-ethanediol, 1,3-propanediol, 1,4-butanediol, 1,5-pentanediol, 1,6-hexanediol, 1,8-octanediol, 1,10-decanediol, 1,12-dodecanediol, diethylene glycol, dipropylene glycol, neopentyl glycol, trimethylolpropane, 1,4-di(hydroxyethyl)hydroquinone, isophoronediamine, 6-methyl-2,4-bis(methylthio)phenylene-1,3-diamine, 2-methyl-4,6-bis(methylthio)phenylene-1,3-diamine and mixtures of at least 2 thereof, even more preferably selected from the group consisting of 1,3-propanediol, 1,4-butanediol, 1,6-hexanediol, trimethylolpropane, isophoronediamine, 6-methyl-2,4-bis(methylthio)phenylene-1,3-diamine, 2-methyl-4,6-bis(methylthio)phenylene-1,3-diamine and mixtures of at least 2 thereof.

Relatively small quantities of triols may also be added.

The proportion of component (C), based on the total mass of the polyurethane elastomer is preferably 0.1 to 20% by weight, particularly preferably 0.1 to 15% by weight, with the provision that the sum of components (A), (B) and (C) in the polyurethane elastomer is 100% by weight. It is also possible that mixtures of chain extenders are used.

The polyurethane elastomer according to the present invention comprises as an optional component at least one catalyst as component (D).

Suitable catalysts can optionally be used in the process of the invention. The conventional tertiary amines known from the prior art, e.g. triethylamine, dimethylcyclohexylamine, N-methylmorpholine, N,N′-dimethylpiperazine, 2-(dimethylaminoethoxy)ethanol, diazabicyclo[2.2.2]octane (DABCO), diethylethanolamine, N-cocomorpholine, N,N-diethyl-3-diethylaminopropylamine dimethylbenzylamine, 1,8-Diazabicycloundec-7-ene (DBU), triazabicyclodecene (TBD) and N-methyltriazabyclodecene (MTBD). Organometallic compounds, for example titanium compounds, iron compounds, bismuth compounds, zinc compounds, or tin compounds, for example tin diacetate, tin dioctanoate, tin dilaurate, or the dialkyltin salts of aliphatic carboxylic acids, for example dibutyltin diacetate or dibutyltin dilaurate, are suitable catalysts for the production of PU elastomers. Preferred catalysts are amine compounds and/or organometallic compounds, in particular tin compounds.

The total quantity of catalysts based on the total mass of the polyurethane cast elastomer is generally about 0 to 5% by weight, preferably 0.0001 to 1% by weight, and particularly preferably 0.0002 to 0.5% by weight.

The polyurethane elastomer according to the present invention comprises as an optional component at least one additive as component (E).

Suitable additives may be lubricants, for example fatty acid esters, metal soaps of these, fatty acid amides, fatty acid ester amides, and silicone compounds, anti-foaming agents, rheological agents such as viscosity regulator, jellification agents, antiblocking agents, inhibitors, stabilizers with respect to hydrolysis, UV or other light, heat, and discoloration, flame retardants, dyes, pigments, inorganic and/or organic fillers, and reinforcing agents. Reinforcing agents are in particular fibrous reinforcing materials, e.g. inorganic fibers, where these are produced in accordance with the prior art and can also have been treated with a size.

In a preferred embodiment, additives (E) used in small amounts may also be customary mono-, di-, tri- or polyfunctional compounds reactive toward isocyanates in proportions of 0.001 mol % up to 2 mol %, preferably of 0.002 mol % to 1 mol %, based on the total molar amount of component A, for example as chain terminators, auxiliaries or demoulding aids. Examples include alcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol and stearyl alcohol. Examples of suitable triols are trimethylolethane, trimethylolpropane or glycerol. Suitable higher-functionality alcohols are ditrimethylolpropane, pentaerythritol, dipentaerythritol or sorbitol. Amines such as butylamine and stearylamine or thiols.

The polyurethane elastomer according to the present invention comprises as an optional component at least one filler as component (F).

Suitable filler are preferable mineral filler selected from the group consisting of CaCO₃, SiO₂, Al(OH)₃, Al₂O₃, CaO, MgO, Na₂O, K₂O, B₂O₃, Fe₂O₃, P₂O₅, zirconia, cerium oxide, TiO₂, silicates, in particular sodium silico-aluminate, calcium silicate, magnesium silicate, mixtures thereof as well hydrated modifications of the mentioned fillers.

The at least one filler which is used according to the present invention has preferably a particle size of 1 to 10 μm, particularly preferably 2 to 8 μm, for example 5 μm.

The present invention also relates to a process for the manufacture the polyurethane elastomer according to the present invention, at least comprising the following steps:
(I) Provision of at least one NCO-terminated prepolymer (A),
(II) Provision of at least one polyol mixture (B),
(III) Provision of at least one chain extender (C),
(IV) Optionally provision of at least one catalyst (D),
(V) Optionally provision of at least one additive (E),
(VI) Optionally at least one filler (F) and
(VII) Reaction of the at least one NCO-terminated prepolymer (A), the at least one polyol mixture (B), the at least one chain extender mixture (C), optionally the at least one catalyst (D), optionally the at least one additive (E) and optionally the at least one filler to obtain the polyurethane elastomer.

The single steps of the process according to the present invention will be described in detail in the following.

Step (I) of the process according to the present invention comprises the provision of at least one NCO-terminated prepolymer (A).

The NCO-terminated prepolymer (A) is obtained from the components as mentioned before. The provision of component (A1) is in general done in a suitable reactor under suitable conditions known to the skilled artisan, for example under vacuum, with a stirrer, and at a temperature of 40 to 100° C. Then the provision of the component (A2) is preferably done in the same reactor under vacuum and the provision of component (A3) is preferably done directly after (A2). The mixture is stirred preferably during 2 to 3 hours at a temperature between 4° and 100° C. Then the product is extracted and stored in a drum under nitrogen or vacuum.

The NCO-terminated prepolymer (A) is obtained from the components as mentioned before. The preparation of a prepolymer is in general known to the skilled artisan in the art.

Step (II) of the process according to the present invention comprises the provision of at least one polyol mixture (B).

The provision of component (B) is in general done in a suitable reactor under suitable conditions known to the skilled artisan, for example under vacuum, and at a temperature of 60 to 80° C.

According to the present invention, the addition of any other component than the NCO-terminated prepolymer (A) as (C), (D), (E) and (F) is preferably done directly after the provision of (B), in the same reactor.

The provision, the measuring and the metering of the single components in steps (I) to (VI) can be done by any method that is known to the skilled artisan, for example by hand, with the use of a balance, by syringes, pumps, automatic weighing in the reactor, low pressure dispensing machine etc.

Step (VII) of the process according to the present invention comprises the reaction of the at least one NCO-terminated prepolymer (A), the at least one polyol mixture (B), the least one chain extender mixture (C), optionally at least one catalyst (D), optionally at least one additive (E) and optionally at least one filler (F) to obtain the polyurethane cast elastomer.

After step (III) and optionally steps (IV), (V) and/or (VI) of the process according to the present invention, all components (A), (B), (C), optionally (D), (E) and (F) are present in a suitable reactor, preferably under an inert atmosphere.

Mixing is done for a time of for example 10 seconds to 3 minutes, preferably 30 to 90 seconds. In parallel to the mixing or after the mixing, the mixture is preferably degassed in a vacuum chamber, in particular according to methods known to the skilled artisan, until the mixture is bubble free, for example for 10 seconds to 2 minutes. Next, the mixture is preferably poured into an open or closed mold, preferably at a temperature of 20 to 120° C., and then cured for 0.1 to 48 hours, preferably at a temperature of 20 to 120° C. The mold as such is also known to the skilled artisan.

The polyurethane cast elastomer is preferably demolded after a certain demolding time, for example 1 minutes to 2 hours, preferably 1 minute to one hour.

Optionally, a so-called maturation step can then be conducted to complete curing and reticulation. This is for example done by setting the cast polyurethane elastomer for 2 to 14 days at a temperature of 10 to 40° C. at 30 to 70% air humidity.

The elastomeric polyurethane according to the present invention shows physical properties which are at least comparable to the physical properties of products being present on the market.

The polyurethane cast elastomers according to the present invention are very advantageous in respect of their physical properties, in particular mechanical properties, for example in respect of a their hardness between 55 Shore A and 95 Shore A, a corresponding Tear Strength between 50 and 160 kN/m and a corresponding Tensile Strength between 39 and 60 kN/m.

The hardness of the polyurethane cast elastomer according to the present invention is therefore preferably 0 Shore A to 90 shores D, preferably 50 Shore A to 95 Shore A, each acquired according to ISO 48-4:2018.

The Tensile Strength of the polyurethane cast elastomer according to the present invention is therefore preferably 30 to 70 MPa, each acquired according to DIN 53504: 2017.

The Tear Strength of the polyurethane cast elastomer according to the present invention is therefore preferably 40 to 170 kN/m, each acquired according to ISO 34-1.

The polyol mixture (B) is obtainable or obtained by a process for the manufacture comprising the steps of
(IIa) Provision of at least one polyester (B1) having a number average molecular weight (Mn) in the range of 900 g/mol to 3000 g/mol and a hydroxyl functionality of ≥1.7 and ≤4, wherein Mn has been determined by gel permeation chromatography,
(IIb) Provision of at least one carbodiimide (B2),
(IIc) Mixing of the at least one polyester (B1) and the at least one carbodiimide (B2)
(IId) Storing the mixture of step (IIc) for at least 4 weeks at 23° C. to obtain the at least one polyol mixture (B).

Step (IIa) of the process according to the present invention comprises the provision of at least one polyester (B1) having a number average molecular weight (Mn) in the range of 900 g/mol to 3000 g/mol and a hydroxyl functionality of ≥1.7 and ≤4, wherein Mn has been determined by gel permeation chromatography.

The at least one polyol mixture (B) can be in general done in a suitable reactor by mixing the at least one polyester polyol (B1) with the at least one carbodiimide (B2) under suitable conditions known to the skilled artisan, for example under vacuum, and at a temperature of 40 to 100° C. during one hour to two hours. Preferably, no solvent is added. The mixture can be stored afterwards in a suitable drum under dry nitrogen or vacuum. However, it is also possible to reduce the storage time below 4 weeks by increasing the temperature to >23° C. The storage time is the time period one has to wait until polyol mixture (B) is formed and may also include transportation time, i. e. after mixing (B1) and (B2), the mixture is stored for two weeks at 23° C. and afterwards transported for additional 2 weeks to another location before the actual use.

According to a preferred embodiment of the present invention, step (IIb) of the process according to the present invention is conducted directly after step (IIa).

Step (IIb) of the process according to the present invention comprises the provision of at least one carbodiimide (B2).

Step (IIb) of the process according to the present can in general be done according to any methods known to the skilled artisan. For example, component (B2) is added to component (B1) which is already present in a suitable reactor. It is also possible that component (B2) is provided in a suitable reactor and component (B1) is added thereto.

The provision, the measuring and the metering of the single components in steps (IIa) and (IIb) can be done by any method that is known to the skilled artisan, for example by hand, with the use of a balance, by syringes, pumps, automatic weighing in the reactor, low pressure dispensing machine etc.

Step (IIc) of the process according to the present invention comprises mixing of the at least one polyester (B1) and the at least one carbodiimide (B2). The mixing can be done by any method that is known to the skilled artisan, for example by hand, with the use of a mixing device. Mixing is done for a time of for example 10 seconds to 3 minutes, preferably 30 to 90 seconds.

Step (IId) of the process according to the present invention comprises storing the mixture of step (IIc) for at least 4 weeks, preferably 4 weeks to 30 weeks, more preferably at least 6 weeks, even more preferably 6 weeks to 30 weeks at a temperature in the range between 20° C. to 30° C., preferably 23° C. to obtain the at least one polyol mixture (B). Step (IId) follows after step (IIc).

According to a first preferred embodiment the process for the preparation of the polyol mixture (B), in particular the steps of provision, are done by hand. According to a preferred embodiment thereof, the at least one polyester (B1) is provided in a suitable reactor, and then the at least one carbodiimide (B2) is added to the prepolymer (A). The mixture comprising all components. According to this embodiment degassing is preferably done on the mixture. The mixture is then mixed preferably by a mixing device and stored for at least 4 weeks at 23° C. to obtain the at least one polyol mixture (B). The polyol mixture (B) is preferably stored for 4 weeks to 30 weeks, more preferably for at least 6 weeks, even more preferably for 6 weeks to 30 weeks, still more preferably for 8 weeks to 25 weeks and even still more preferably for 10 weeks to 24 weeks at 23° C. after mixing of (B1) and (B2).

The polyurethane elastomer according to the present invention are very useful in challenging applications, in particular in the mining, quarry and cement industry applications as well as in offshore and marine applications, pulp and paper applications, shoe soles, railway applications, military applications, transport applications, industrial rolls, industrials tires, electric encapsulation, wheels, rollers, doctor blades, hydro cyclones, sieves, sport tracks, insulating panels, acoustic insulations, wind blades or bumpers.

The present application therefore relates also to the use of the polyurethane elastomer according to the invention or the kit-of-parts according to the invention for the manufacture of equipment for the mining, quarry or cement industry. The equipment is preferably a mining screen, a vibrating screen deck, a trommel, a scraper, a grinding mill, an internal pipelining, a conveyor roller, a hydro cyclone, a pump body, a zero crush wheel or a floating cell. The grinding mill might be and includes an automatic, a semi-automatic, a ball mill, a isamill and/or a vertimill. The mining screen might be and include a mono layer screen, a duo layer screen, and/or a multi layer screen, such as freely vibrating screens, grizzly screens, resonance screens, sizing screens and/or dewatering screens.

The present invention therefore also relates to mining equipment, quarry equipment or cement industry equipment comprising or containing at least one polyurethane elastomer according to the present invention or at least kit-of-parts according to the present invention.

The present invention therefore also relates to a Mining screen, a vibrating screen deck, a trommel, a scraper, a grinding mill, an internal pipelining, a conveyor roller, a hydro cyclone, a pump body, a zero crush wheel or a floating cell comprising or containing at least one polyurethane elastomer according to the present invention or at least kit-of-parts according to the present invention.

The present invention therefore also relates to the use of the polyurethane elastomer according to the present invention or at least kit-of-parts according to the present invention in offshore and marine applications, pulp and paper applications, shoe soles, railway applications, military applications, transport applications, industrial rolls, industrials tires, electric encapsulation, wheels, rollers, doctor blades, hydro cyclones, sieves, sport tracks, insulating panels, acoustic insulations, wind blades or bumpers.

The present invention therefore also relates to shoe soles, wheels and rollers, bend restrictors and bend stiffeners, piggy back clamps, fenders, cable ducting, buoyancy, J-tubes seals, leading edge protection, protective mats, dampening pads, dunnage, tensioner pads, field joint, pigs, rip grids floor, anvil cover and truck lining, sealants and railway soles, industrial tires and rolls, sieves, sport tracks, insulating panels, acoustic insulations, wind blades or bumpers comprising or containing at least one polyurethane elastomer according to the present invention or at least kit-of-parts according to the present invention.

The polyurethane according to the invention may be also part of a composition or of a polymer blend or of a polymer composite. Therefore another embodiment is a composition comprising or containing at least one polyurethane elastomer according to the present invention and at least one additive that is different to the optional additive (E).

Another embodiment is a polymer blend comprising or containing at least one polyurethane elastomer according to the present invention and at least one polymer different to the at least one polyurethane elastomer. The at least one polymer is preferably a polyurethane, a thermoplastic polyurethane, a polyurethane elastomer, polyepoxides or rubber.

Another embodiment is a polymer composite comprising or containing at least one polyurethane elastomer according to the present invention and at least one polymer different to the at least one polyurethane elastomer. The at least one polymer is preferably a polyurethane, a thermoplastic polyurethane, a polyurethane elastomer, polyepoxides or rubber.

Another embodiment is composite comprising or containing at least one polyurethane elastomer according to the present invention and at least one other material such as metal, glass, wood or fabric, preferably metal.

The present invention is elucidated by the following examples.

### EXAMPLES

Unless indicated otherwise, all percentages are based on weight.

Unless stated otherwise, all analytical measurements relate to temperatures of 23° C.

The following material were used:

TABLE 1
used raw materials

| | | | | Hydroxyl | molecular | | |
|---|---|---|---|---|---|---|---|
| Commercial | | | Isocyanate | value | weight | | |
| name | Supplier | Type | value (%) | (mgKOH/g) | (g/mol) | Functionality | Initiator |
| DESMODUR ® | Covestro | MDI ester - NCO | 16.3% | — — | — | | |
| FLS88 | | terminated prepolymer | | | | | |
| DESMOPHEN ® | Covestro | Polyadipate polyol | — | 56.8-1975 | — | 2 | Adipic |
| 20555-1A | | | | g/mol | | | acid |
| BURASTAB ® | Baur, Gaebel | Polycarbodiimide | — | | — | — | — |
| MS | GmbH | | | | | | |
| BAYTEC ® XL | Covestro | butane diol | — | — | 92 | 2 | — |
| B | | | | | | | |
| ARCOL ® | Covestro | Polypropylene glycol | — | 111.90-1003 | — | | |
| POLYOL PPG | | | | g/mol | | | |
| 1000 | | | | | | | |
| TOYOCAT- | Tosoh | 1,8-Diazabicyclo- | — | — | 152 | | |
| DB 40 | | (5.4.0)-undec-7-en | | | | | |
| TIB KAT ® 214 | Tib | Diisooctyl 2,2′- | — | — | 752 | | |
| | Chemicals | [(dioctylstannylene)bis | | | | | |
| | | (thio)]diacetate | | | | | |

### Test Methods:

### Hydroxyl Value:

Measurements of Hydroxyl value (mgKOH/g) were done in accordance with norm ISO 4629-2 (2016).

### Mn Determination:

The number-average molecular weight (Mn) was determined by gel permeation chromatography (GPC) in tetrahydrofuran at 23° C. The procedure is according to DIN 55672-1: “Gel permeation chromatography, Part 1—Tetrahydrofuran as eluent” (SECurity GPC System from PSS Polymer Service, flow rate 1.0 ml/min; columns: 2×PSS SDV linear M, 8×300 mm, 5 μm; RID detector). Polystyrene samples of known molar mass are used for calibration. The number-average molecular weight is calculated with software support. Baseline points and evaluation limits are fixed in accordance with DIN 55672 Part 1.

### Isocyanate Value:

Measurements of Isocyanate value (%) were done in accordance with ISO 14896:2009

### Water Absorption:

Measurements of water absorption were done in accordance with DIN EN ISO 62 (2008).

### Tensile Strength:

Measurements in the tensile test in accordance with ISO 53504 (2009) at a pulling rate of 500 mm/min.

### Tear Resistance

Measurements of Tear resistance and Tear resistance with nick were done in accordance with ISO 34-1 (2010).

### Abrasion:

Measurements of Abrasion were done in accordance with ISO 4649 (2017).

### Hardness:

The Shore hardness was measured in accordance with DIN ISO 48-4 (2018).

### Ageing Test:

The elastomers were each stored in a climate-controlled cabinet at 23° C. at 50% atmospheric humidity in accordance with ISO 291 (2008). After 7 days, the mechanical properties were measured and the water absorption test was begun.

### Preparation of Polyol Mixture (B)

96.3 g of DESMOPHEN® 20555-1A was stirred at 70° C. under vacuum. 3.7 g of BURASTAB MS was added and the mixture was stirred during 1 hour under vacuum at 70° C. Then the product is stored under vacuum and matured for at least 8 weeks, at 23° C.

### Preparation of Catalyst

97.9 g of ARCOL® POLYOL PPG 1000 was stirred at 25° C. under vacuum. 1.7 g of TOYOCAT-DB 40 and 0.37 g of TIB KAT 214 were added and the mixture was stirred during 1.5 hour under vacuum at 25° C.

### Preparation of Polyurethane Elastomers

### Example 1 (PU 1: Comparative Example)

0.9 g of CATALYST, 125 g of DESMOPHEN® 20555-1A preheated at 70° C. and 11.7 g of BAYTEC® XL B preheated at 40° C. were weighted in a flask. 100 g of DESMODUR® FLS88 preheated at 40° C. was added and the mixture was stirred during 30 seconds to 1 minute. Then vacuum was applied to degas the reaction mixture until bubble free. The mixture was poured into a closed mold at a temperature of 100° C. for 30 minutes. Then, the part was demolded and post cured at 80° C. for 16 hours.

The sheet was matured 7 days at 23° C. and 50% relative humidity

### Example 2 (PU 2: Comparative Example)

0.9 g of CATALYST, 4.6 g of BURASTAB MS, 125 g of DESMOPHEN® 20555-1A. preheated at 70° C. and 11.7 g of BAYTEC® XL B preheated at 40° C. were weighted in a flask. 100 g of DESMODUR® FLS88 preheated at 40° C. was added and the mixture was stirred during 30 seconds to 1 minute. Then a vacuum was applied to degas the reaction mixture until bubble free. The mixture was poured into a closed mold at a temperature of 100° C. for 30 minutes. Then, the part was demolded and post cured at 80° C. for 16 hours.

A maturation step of 7 days at 23° C. and 50% relative humidity was done on the sheet.

### Example 3 (PU 3: According to the Invention)

0.7 g of CATALYST, 125 g of polyol mixture (B) preheated at 70° C. and 11.7 g of BAYTEC® XL B preheated at 40° C. were weighted in a flask. 100 g of DESMODUR® FLS88 preheated at 40° C. was added and the mixture was stirred during 30 seconds to 1 minute. Then a vacuum was applied to degas the reaction mixture until bubble free. The mixture was poured into a closed mold at a temperature of 100° C. for 30 minutes. Then, the part was demolded and post cured at 80° C. for 16 hours.

A maturation step of 7 days at 23° C. and 50% relative humidity was done on the sheet.

### Hydrolysis Resistance at 70° C.

The assessment of resistance to hydrolysis was done by comparison of a reference system to the inventive system.

As a reference system example 1 (PU 1) was used and qualified according to the following parameters that were monitored as a function of immersion.

A temperature—70° C.—and an immersion time were defined—63 days, as well as the monitoring frequency—1 week. For each measurement point, a set of test specimens was immersed (1 to 3 specimens depending on the test performed).

### Equipment

### Thermostatic Bath and Baskets

The immersion of samples required a thermostatic bath with sufficient capacity to accommodate all the test specimens tested during the test.

The thermostatic bath used has a capacity of 22 litres (WNB 22 Memmert).

Conventional tests were carried out in tap water.

### Test Equipment

Water absorption, Hardness evolution, Tensile Strength and Abrasion Resistance values were followed. The test equipments and samples/specimens needed were:
Hardness DIN ISO 48-4 (2018): Durometer. 1 specimen per test point was required and the sample was put back in the bath.
Tensile Strength ISO 53504 (2009): ZWICK machine. 3 specimens per test point are required.
Abrasion ISO 4649 (2017): Abrasimeter. 3 specimens per test point were required.
Mass: precision balance according to ISO 062. 1 specimen per test point was required and the sample was put back in the bath.

### Type of Specimens

The shape and size of the specimen depends on the standard to be followed for measuring the parameter that was monitored.
For the measurement of mechanical properties (stress and tension), we followed the DIN 53504 standard;
For the measurement of abrasion, we followed the ISO 4649 standard;
To measure the evolution of the mass of the material, we followed the ISO 062 standard.

For mass monitoring (non-destructive test): the measurements were taken on the mass monitoring sample. After the measurement the sample is put back in the bath.

For hardness monitoring: the measurements were taken on the hardness monitoring sample. After the measurement the sample was put back in the bath.

For abrasion, tensile and elongation monitoring: 3 samples were necessary and the samples were destroyed.

### Reference Test: T0

A set of samples is taken without any prior preparation other than conditioning after maturation. All the tests (Hardness, Tensile Strength, Mass, Abrasion) were done.

### Immersion Test

The temperature of the thermostatic bath was 70° C.

The volume of water in the thermostatic baths was kept constant throughout the test (at 70° C., it was necessary to check the water level very regularly).

### Immersion of Test Specimens

The various samples were placed flat, in maximum surface contact with the water.

### Conditioning of the Test Specimens Before Testing

### Conditioning of Specimens for Mechanical Evaluation (Tensile Strength)

### Reference Test: T0

The set of test specimens was conditioned in a climatic chamber at a temperature of 23±2° C., under a relative humidity of 50±5% for at least 88 hours before the test (refer to ISO 291/2008(F)).

### Weekly Test: T×7 Days

The set of test specimens was taken out of the thermostatic bath and conditioned for 24H in water at 23±2° C. Before being tested, the test samples were wiped with paper to remove the water on the surface.

### Conditioning of the Test Specimens for Evaluation of Mass

### Reference Test: T0

Two test specimens were kept at (50.0±2.0°) C for at least 24 hours before being weighed to the nearest 0.1 mg. Weighing was carried out immediately on leaving the oven.

### Weekly Test: T×7 Days

The test sample was removed from the thermostatic bath and conditioned for 2 hours in water at 23±2° C. The test sample was then wiped to remove the water on the surface and weighed immediately.

The test sample was then put back into the thermostatic bath.

### Conditioning of the Test Tubes for Hardness Evaluation

### Reference Test: T0

The test specimen was conditioned at a temperature of 23±2° C., with a relative humidity of 50±5% for at least 88 hours before testing (refer to ISO 291/2008(F)).

### Weekly Test: T×7 Days

The test sample was taken out of the thermostatic bath and conditioned for 2 hours in water at 23±2° C. The measurement was then carried out and the test sample is put back in the thermostatic bath.

### Conditioning of Specimens for Abrasion Evaluation

### Reference Test: T0

The test specimen was conditioned at a temperature of 23±2° C., with a relative humidity of 50±5% for at least 88 hours before the test (refer to ISO 291/2008(F)).

### Weekly Test: T×7 Days

The test sample was taken out of the thermostatic bath and conditioned for 24 hours in water at 23±2° C. On the day of the test, the measurements were carried out.

### Results

### Expression of Results

Each parameter change was expressed as a percentage of the reference value (TO).
Evolution of the mass: EM

$$EM = ( {M}_{Txj} - {M}_{T 0} ) / {M}_{T 0} * 100$$

EM: % change in mass at x days
M_{Txd}: mass at x days
M_{T0}: mass at T₀
Tensile strength evolution: EC

$$EC = ( {C}_{Txj} - {C}_{T 0} ) / {C}_{T 0} * 100$$

CM: % of evolution of the tensile strength after x days
C_{Txj}: tensile at x days
C_{T0}: tensile at T0
Mass evolution: EM

$$EM = ( {M}_{Txj -} - {M}_{T 0} ) / {M}_{T 0} * 100$$

EM: % of evolution of the mass at x days
M_{Txj}: mass at x days
M_{T0}: mass at T0

### Results

TABLE 2
Water absorption: mass evolution (in grams and % of evolution)
Samples measured each week:

| | Time of immersion (in days) | | | | | | |
|---|---|---|---|---|---|---|---|
| | (T0) 0 | 7 | 14 | 21 | 28 | 35 | 42 |
| PU | 9.4262 | 9.6232 | 9.6024 | 9.5611 | 9.391 | 8.998 | 8.3424 |
| 1 | — | +2.09% | +1.87% | +1.43% | −0.37% | −4.54% | −11.50% |
| PU | 9.8987 | 10.2700 | 10.3063 | 10.3375 | 10.2724 | 10.2383 | 9.9254 |
| 2 | — | +3.75% | +4.12% | +4.43% | +3.78% | +3.43% | +0.27% |
| PU | 9.3004 | 9.4798 | 9.4788 | 9.4676 | 9.471 | 9.4513 | 9.4303 |
| 3 | — | +1.93% | +1.92% | +1.80% | +1.83% | +1.62% | +1.40% |

PU 1: After 21 days of immersion at 70° C., the material loses mass to −11.5%.
PU 2: The addition of BURASTAB MS additive significantly increased the water absorption of the material. Indeed, after 14 days, the material has absorbed +4.12% of its weight in water, which is more than double that of PU1. The destruction of the elastomer is therefore delayed by a fortnight.
PU 3: Maturation of the BURASTAB MS additive in the polyester polyol made it possible to limit the swelling of the elastomer to a maximum of +1.83% of its weight in water and to delay the destruction of the system. Between 28 and 42 days of immersion at 70° C., the mass of the sample decreased, which reflects the destruction of the system, but more gradually than PU 1 and PU 2.

TABLE 3
Hardness (in Shore A and % of evolution)

| | Time of immersion (in days) | | | | | | | | | | |
|---|---|---|---|---|---|---|---|---|---|---|---|
| | 0 | 7 | 14 | 21 | 28 | 35 | 42 | 49 | 56 | 63 | 70 |
| PU 1 | 75 | 66 | 60 | 50 | 44 | 15 | 8 | — | — | — | — |
| | — | −12% | −20% | −33% | −41% | −80% | −89% | | | | |
| PU 2 | 75 | 64 | 64 | 54 | 48 | 21 | 13 | 7 | — | — | — |
| | — | −14% | −14% | −27% | −35% | −72% | −83% | −91% | | | |
| PU 3 | 75 | 66 | 66 | 65 | 63 | 61 | 59 | 51 | 39 | 15 | 4 |
| | — | −12 | −12% | −13% | −16% | −19% | −21% | −32% | −48% | −80% | −95% |

The absorption of water into the elastomer and then the loss of material lead to a drop in the hardness of the material: the matrix gradually ‘softens’.

In the case of the three elastomers, a progressive drop in hardness was observed. Only PU 3 showed a loss plateau at −15% between 14 and 35 days.
PU 1: 89% hardness loss was reached after 42 days.
PU 2: 91% hardness loss was reached after 49 days. The addition of the BURASTAB MS additive therefore delayed the hydrolytic effect by about 7 days at 70° C. compared to PU 1.
PU 3: 95% hardness loss was achieved after 70 days and 80% after 63 days. The maturation of the carbodiimide in the polyester polyol therefore plays a significant role, since it delayed the hardness loss due to hydrolysis by at least 14 days compared to PU 2 (without maturation) and in fact by about 20 days (between 14 and 21).

TABLE 4
Tensile Strength (in MPa and relative
change of tensile strength in %)

| | Time of immersion (in days) | | | | | | | | |
|---|---|---|---|---|---|---|---|---|---|
| | 0 | 7 | 14 | 21 | 28 | 35 | 42 | 49 | 56 |
| PU 1 | 58 | 19 | 2 | — | — | — | — | — | — |
| | — | −67% | −97% | | | | | | |
| PU 2 | 58 | 28.0 | 5.0 | 1.0 | — | — | — | — | — |
| | — | −46% | −90% | −98% | | | | | |
| PU 3 | 56.0 | 40 | 38.0 | 34.0 | 33.0 | 28.0 | 21.7 | 9.4 | 2.0 |
| | — | −29% | −32% | −39% | −41% | −50% | −61% | −83% | −96% |

Mechanical properties were also affected by hydrolysis mechanism.
PU 1: 97% loss of tensile strength was achieved after 14 days of immersion at 70° C.
PU 2: 98% loss of Tensile Strength was achieved after 21 days of immersion. The additive BURASTAB MS (composed of carbodiimides) delayed the effect of hydrolysis on tensile strength by about 7 days.
PU 3: 96% loss of tensile strength was achieved after 56 days of immersion at 70° C. Maturation of BURASTAB MS (carbodiimides) in polyester polyol therefore improved the resistance to hydrolysis by 35 days, particularly from the point of view of tensile strength, compared to PU 2 without maturation.

TABLE 5
Abrasion Resistance (in mm³)

| | Time of immersion (in days) | | | | | | |
|---|---|---|---|---|---|---|---|
| | 0 | 7 | 14 | 21 | 35 | 42 | 49 |
| PU 1 | 7 | 35 | 102 | 353 | 1000 | — | — |
| PU 2 | 11 | 21 | 236 | 1023 | — | — | — |
| PU 3 | 17 | 27.5 | 41 | 38 | 67 | 126 | 507 |

Abrasion resistance was also tested under hydrolysis.

The results were different here as the addition of BURASTAB MS had no positive impact on the reference system (PU2 vs PU1).

On the other hand, the maturation of BURASTAB MS in polyester polyol delayed hydrolysis by at least 14 days compared to the reference system PU 1, according to the results.

1. A polyurethane elastomer reaction product comprising:
(A) at least one NCO-terminated prepolymer,
(B) at least one polyol mixture comprising:
(B1) at least one polyester polyol having a number average molecular weight (Mn) in the range of 900 g/mol to 3000 g/mol and a hydroxyl functionality of ≥1.7 and ≤4, wherein Mn has been determined by gel permeation chromatography and
(B2) at least one carbodiimide,
(C) at least one chain extender,
(D) optionally at least one catalyst,
(E) optionally at least one additive, and
(F) optionally at least one filler.

2. The polyurethane elastomer reaction product of claim 1,
wherein the polyol mixture (B) was stored for at least 4 weeks at 23° C. or greater after mixing of (B) and (B2).

3. The polyurethane elastomer reaction product of claim 1, wherein the at least one NCO-terminated prepolymer (A) is a reaction product comprising:
(A1) at least one polyisocyanate comprising at least two isocyanate groups, and
(A2) at least one polyol having a number average molecular weight (Mn) in the range of 900 g/mol to 3000 g/mol and a hydroxyl functionality of ≥1.7 and ≤4, wherein Mn has been determined by gel permeation chromatography,
(A3) optionally, at least one polyol having a molecular weight in the range of 90 g/mol and 150 g/mol, and
(A4) optionally, at least one catalyst or at least one additive.

4. The polyurethane elastomer reaction product of claim 1, wherein the at least one NCO-terminated prepolymer (A) is a reaction product comprising:
(A1) least one polyisocyanate (A1) selected from the group consisting of aromatic diisocyanates, toluene-2,4-diisocyanate (2,4-TDI), toluene-2,4-diisocyanate (2,4-TDI)/toluene-2,6-diisocyanate (2,6-TDI) mixtures, diphenylmethane-4,4′-diisocyanate (4,4′-MDI), diphenylmethane-2,4′-diisocyanate (2,4′-MDI), diphenylmethane-2,2′-diisocyanate (2,2′-MDI), diphenylmethane-2,4′-diisocyanate (2,4′-MDI)/diphenylmethane-4,4′-diisocyanate (4,4′-MDI) mixtures, urethane-modified liquid diphenylmethane-4,4′-diisocyanates and diphenylmethane-2,4′-diisocyanates, 4,4′-diisocyanato-1,2-diphenylethane, naphthylene-1,5-diisocyanate and mixtures of at least 2 thereof, more preferably selected from the group consisting of diphenylmethane-4,4′-diisocyanate (4,4′-MDI), diphenylmethane-2,4′-diisocyanate (2,4′-MDI), diphenylmethane-2,4′-diisocyanate (2,4′-MDI)/diphenylmethane-4,4′-diisocyanate (4,4′-MDI) mixtures, diphenylmethane-2,2′-diisocyanate (2,2′-MDI) and mixtures of at least 2 thereof,
(A2) at least one polyol having a number average molecular weight (Mn) in the range of 900 g/mol to 3000 g/mol and a hydroxyl functionality of ≥1.7 and ≤4, wherein Mn has been determined by gel permeation chromatography, selected from the group consisting of polyester polyol, polyether polyol, polyether carbonate polyol and mixtures of at least 2 thereof,
(A3) optionally, at least one polyol having a molecular weight in the range of 90 g/mol and 150 g/mol, and having a hydroxyl functionality of ≥2 and ≤4, wherein the content of (A3) is in the range of 0.5 to 5 wt. % based on the total weight of the at least one NCO-terminated prepolymer (A), and
(A4) optionally at least one catalyst or at least one additive.

5. The polyurethane elastomer reaction product of claim 1, wherein the at least one polyol mixture (B) comprises:
(B1) at least one polyester polyol having a number average molecular weight (Mn) in the range of 1000 g/mol to 2500 g/mol and a hydroxyl functionality of ≥1.7 and ≤4, wherein Mn has been determined by gel permeation chromatography, and
(B2) at least one polycarbodiimide, wherein the content of (B2) is in the range of 1 to 5 wt. % based on the total weight of the at least one polyol mixture.

6. The polyurethane elastomer reaction product of claim 1, wherein polyol mixture (B) was stored for 10 weeks to 24 weeks at 23° C. after mixing of (B1) and (B2).

7. The polyurethane elastomer reaction product of claim 1, wherein the at least one chain extender (C) is selected from the group consisting of 1,2-ethanediol, 1,2-propanediol, 1,3-propanediol, 1,2-butanediol, 1,3-butanediol, 1,4-butanediol, 1,5-pentanediol, 2,2-dimethylpropane-25 1,3-diol, 2-butyl-2-ethyl propane-1,3-diol, 2-methyl-2,4-pentane diol, 2-ethyl-1,3-hexane diol, 2-methyl-1,3-propane diol, 1,5-hexanediol, 1,6-hexanediol, 1,8-octanediol, 1,10-decanediol, 1,12-dodecanediol, 2,2,4,4-tetramethylcyclobutane-1,3-diol, 1,3-cyclopentanediol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, 1,4-cyclohexanediethanol, isosorbide, glycerol, glycerol monoesters, glycerol monoethers, trimethylolpropane, trimethylolpropane monoesters, trimethylolpropane monoethers, pentaerythritol diesters, pentaerythritol diethers, and alkoxylated derivatives of any of these, diethylene glycol, triethylene glycol, tetraethylene glycol, dipropylene glycol, tripropylene glycol, bis(ethylene glycol)terephthalate, bis(1,4-butanediol)terephthalate, 1,4-di(hydroxyethyl)hydroquinone, isophoronediamine, ethylenediamine, 1,2-propylenediamine, 1,3-propylenediamine, N-methylpropylene-1,3-diamine, N,N′-dimethylethylenediamine, 2,4-toluenediamine and 2,6-toluenediamine, 6-methyl-2,4-bis(methylthio)phenylene-1,3-diamine and 2-methyl-4,6-bis(methylthio)phenylene-1,3-diamine, 3,5-diethyl-2,4-toluenediamine, 3,5-diethyl-2,6-toluenediamine and mixtures of at least 2 thereof.

8. A method for the manufacture of the polyurethane elastomer reaction product of claim 1, comprising the steps of:
(I) Provision of at least one NCO-terminated prepolymer (A),
(II) Provision of at least one polyol mixture (B),
(Ill) Provision of at least one chain extender (C),
(IV) Optionally provision of at least one catalyst (D),
(V) Optionally provision of at least one additive (E),
(VI) Optionally at least one filler (F) and
(VII) Reaction of the at least one NCO-terminated prepolymer (A), the at least one polyol mixture (B), the at least one chain extender mixture (C), optionally the at least one catalyst (D), optionally the at least one additive (E) and optionally the at least one filler to obtain the polyurethane elastomer.

9. The method for the manufacture of the polyurethane elastomer reaction product of claim 8, further comprising the steps of
(IIa) Provision of at least one polyester (B1) having a number average molecular weight (Mn) in the range of 900 g/mol to 3000 g/mol and a hydroxyl functionality of ≥1.7 and ≤4, wherein Mn has been determined by gel permeation chromatography,
(IIb) Provision of at least one carbodiimide (B2),
(IIc) Mixing of the at least one polyester (B1) and the at least one carbodiimide (B2)
(IId) Storing the mixture of step (IIc) for at least 4 weeks at 23° C. to obtain the at least one polyol mixture (B).

10. A mining equipment comprising the polyurethane elastomer reaction product of claim 1, wherein the equipment is a mining screen, a vibrating screen deck, a trommel, a scraper, a grinding mill, an internal pipelining, a conveyor roller, a hydro cyclone, a pump body, a zero crush wheel or a floating cell.

11-13. (canceled)

14. A product comprising a polyurethane elastomer reaction product of claim 1, where the product is a shoe soles, wheels and rollers, bend restrictors, bend stiffeners, piggy back clamps, fenders, cable ducting, buoyancy product, J-tubes seals, leading edge protection, protective mats, dampening pads, dunnage, tensioner pads, field joint, pigs, rip grids floor, anvil cover, truck lining, sealants, railway soles, industrial tires, rolls, sieves, sport tracks, insulating panels, acoustic insulations, wind blades or bumpers.

15. A polymer blend or polymer composite comprising the polyurethane elastomer reaction product of claim 1 and at least one polymer different from the polyurethane elastomer reaction product, wherein the at least one polymer is a polyurethane, a thermoplastic polyurethane, a polyurethane elastomer, a polyepoxides or a rubber.

16. The polyurethane elastomer reaction product of claim 4, wherein (A2) is polyester polyol having a number average molecular weight (Mn) in the range of 1000 g/mol to 2500 g/mol and a hydroxyl functionality of ≥1.7 and ≤4, wherein Mn has been determined by gel permeation chromatography.

17. The polyurethane elastomer reaction product of claim 7, wherein the at least one chain extender (C) is selected from the group consisting of 1,2-ethanediol, 1,3-propanediol, 1,4-butanediol, 1,5-pentanediol, 1,6-hexanediol, 1,8-octanediol, 1,10-decanediol, 1,12-dodecanediol, diethylene glycol, dipropylene glycol, neopentyl glycol, trimethylolpropane, 1,4-di(hydroxyethyl)hydroquinone, isophoronediamine, 6-methyl-2,4-bis(methylthio)phenylene-1,3-diamine, 2-methyl-4,6-bis(methylthio)phenylene-1,3-diamine and mixtures of at least 2 thereof.

18. The polyurethane elastomer reaction product of claim 7, wherein the at least one chain extender (C) is selected from the group consisting of 1,3-propanediol, 1,4-butanediol, 1,6-hexanediol, trimethylolpropane, isophoronediamine, 6-methyl-2,4-bis(methylthio)phenylene-1,3-diamine, 2-methyl-4,6-bis(methylthio)phenylene-1,3-diamine and mixtures of at least 2 thereof.
